SEQUENCE LISTING (9 sequences)

SEQ ID NO: 1 - protein, 16 aa, Gallus gallus
  BINDING 8: NITRATION
NTDGSTDYGILQINSR

SEQ ID NO: 2 - protein, 7 aa, Gallus gallus
  BINDING 6: NITRATION
HGLDNYR

SEQ ID NO: 3 - protein, 16 aa, Gallus gallus
NTDGSTDYGILQINSR

SEQ ID NO: 4 - protein, 7 aa, Gallus gallus
HGLDNYR

SEQ ID NO: 5 - protein, 15 aa, Gallus gallus
IVSDGNGMNAWVAWR

SEQ ID NO: 6 - protein, 12 aa, Gallus gallus
GYSLGNWVCAAK

SEQ ID NO: 7 - protein, 9 aa, Gallus gallus
GTDVQAWIR

SEQ ID NO: 8 - protein, 7 aa, Artificial Sequence
  synthetic peptide
CLKDRHD

SEQ ID NO: 9 - protein, 11 aa, Artificial Sequence
  synthetic peptide
HKARVLFEALS

(19) United States
(12) Patent Application Publication
(10) Pub. No.: US 2006/0243899 A1
(43) Pub. Date: Nov. 2, 2006

(54) Method for selective measurement of specific substances from a mixture by maldi mass spectrometry

(75) Inventors: Eiichi Matsuo, Kyoto-shi (JP); Chikako Toda, Kyoto-shi (JP); Makoto Watanabe, Osaka-shi (JP); Osamu Nishimura, Kawanishi-shi (JP); Noriyuki Ojima, Kyoto-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: SHIMADZU CORPORATION

(21) Appl. No.: 11/028,230

(22) Filed: Jan. 4, 2005

(30) Foreign Application Priority Data
May 24, 2004 (JP) 2004-153484

(51) Int. Cl. B01D 59/44

(52) U.S. Cl. 250/282

(57) ABSTRACT

The present invention provides a method which is capable of mainly detecting the objective substance by mass spectrometry and can also be applied effectively to a sample to be measured without conducting enrichment process. A mass spectrometric method comprising: in a mass spectrometry specifically ionizing a specific substance to be measured contained in a mixture sample containing the specific substance and a substance other than the specific substance by using a matrix that is more likely to ionize the specific substance than the substance other than the specific substance, to selectively measure the specific substance from the mixture. Preferably, the specific substance is a peptide modified with 2-nitrobenzenesulfenyl chloride, and the matrix is a nitrobenzene derivative such as hydroxynitrobenzoic acid. The matrix is preferably used in combination with α-cyano-4-hydroxycinnamic acid.

### BACKGROUND OF THE INVENTION

1. Field of the Invention

The present invention relates to mass spectrometry and quantitative proteome analysis by a MALDI (Matrix Assisted Laser Desorption/Ionization)) method.

2. Disclosure of the Related Art

<Mass Spectrometry Based on the MALDI Method>

In a MALDI mass spectrometer, molecules (generally organic compounds) called “matrix” with an analyte are heated by absorption of energy of a laser beam, and vaporized and ionized. Due to instant vaporization of the matrix surrounding analyte molecules, the analyte molecules are also, as a result, almost simultaneously released into a gas phase. (At this time, electrons or protons are passed between the analyte molecules and the matrix, and thus the ionization of the analyte molecules is achieved.) In mass spectrometry according to the MALDI method, an optimum organic compound for each analyte to be measured is searched and used. For example, in measurement of a peptide, α-cyano-4-hydroxycinnamic acid (4-CHCA), 2,5-dihydroxybenzoic acid (DHB) are generally used.

<Proteome Analysis>

In the field of proteome analysis (global analysis of protein), a PMF (Peptide Mass Finger Printing) analysis method in which a two-dimensional electrophoresis and a mass spectrometer are combined is commonly used. As a next-generation proteome analysis method which will be an alternative to the PMF, for example, approaches using stable isotopes as disclosed in: Steven P. Gygi, Beate Rist, Scott A. Gerber, Frantisek Turecek, Michael H. Gelb and Ruedi Aebersold, Quantitative analysis of complex protein mixtures using isotope-coded affinity tags, Nature Biotechnology, 994-999, 17, 1999; Kirk C. Hansen, Gerold Schmitt-Ulms, Robert J. Chalkley, Jan Hirsch, Michael A. Baldwin and A. L. Burlingame, Mass Spectrometric Analysis of Protein Mixtures at Low Levels Using Cleavable ¹³C-Isotope-coded Affinity Tag and Multidimensional Chromatography, Molecular & Cellular PROTEOMICS, 299-314, 2, 2003; and, Salvatore Sechi and Yoshiya Oda, Quantitative proteomics using mass spectrometry, Current Opinion in Chemical Biology, 70-77, 7, 2003 have been contrived.

In Hiroki Kuyama, Makoto Watanabe, Chikako Toda, Eiji Ando, Koichi Tanaka and Osamu Nishimura, An Approach to Quantitative Proteome Analysis by Labeling Tryptophan Residues, Rapid Communications in Mass Spectrometry, 1642-1650, 17, 2003, and the international publication WO 2004/002950 pamphlet, a method developed by the present inventors (NBS method) is disclosed. The NBS method uses stable isotope-labeled 2-nitrobenzenesulfenyl chloride (NBSCl) (2-nitro[¹³C₆]benzenesulfenyl chloride) and non-labeled NBSCl (2-nitro[¹²C₆]benzenesulfenyl chloride). Specifically, the method includes the steps of: (1) preparing two states of protein samples, a protein sample I to be analyzed and its reference protein sample II; (2) modifying the protein sample I with either one of 2-nitro[¹³C₆]benzenesulfenyl chloride and 2-nitro[¹²C₆]benzenesulfenyl chloride, while modifying the protein sample II with the other one of 2-nitro[¹³C₆]benzenesulfenyl chloride and 2-nitro[¹²C₆]benzenesulfenyl chloride; (3) mixing the modified protein sample I and the modified protein sample II with each other; (4) removing unreacted reagents by using a desalting column; (5) subjecting the resultant mixture of modified proteins to reduction and alkylation followed by digestion into a peptide mixture containing modified peptide fragments and unmodified peptide fragments; (6) enriching/separating the modified peptide fragments from the peptide mixture by using a hydrophobic chromatography column; and (7) conducting mass spectrometry.

<Nitrotyrosine>

It is known that, in a living organism, nitrogen monoxide (NO) and highly-reactive nitrogen oxides generating therefrom (such as peroxynitrite) will react with proteins or nucleic acids to generate nitro compounds. For example, in the case of a protein, reaction occurs at a phenyl group which is a side chain of tyrosine to generate 3-nitrotyrosine. Tyrosine residues are frequently phosphorylated in a living organism. Phosphorylation has a role of a switch in critical events in a living organism such as signal transduction and cell death. For this reason, living organism-related substances having a nitrotyrosine receive attention not only as an index for generation of a reactive nitrogen oxide in a living organism (so-called “bio-marker”) but also from the view point of biological activity.

A nitrating method of a tyrosine residue in a protein is disclosed in: A reagent for the nitration of tyrosine and tyrosyl residues of proteins, Journal of the American Chemical Society, 1966, 88, 4104-410; and, A reagent for the nitration of tyrosyl residues in proteins, Biochemistry, 1966, 5, 3582-3589.

### SUMMARY OF THE INVENTION

In the MALDI method, vaporization and ionization of a analyte/matrix mixture is conducted by irradiation with a laser beam, and the number of molecules that can be ionized in a single shot is limited. Accordingly, when the sample to be measured includes a plurality of molecule species, a molecular species existing at high abundance is ionized at higher probability, while a molecular species existing at low abundance is detected at less probability even if an amount exceeding a detection limit of the analyte exists. Also in the case where there is a difference in “ionization tendency” between analyte molecules to be measured, molecules having poor tendency to ionization can be detected with poor sensitivity. Therefore, it is important to enrich an objective molecule in advance in order to detect a molecular species that is hard to be ionized and a molecular species that exists in a small amount.

In the NBS method, one of other analyses that require quantification, detection of an NBS-modified molecule which is an objective molecule can be done without enrichment, however, the quantitativeness may be impaired if the NBS-modified molecule overlaps with irrelative molecules. Therefore, still in this case, it would be preferable to remove in advance the molecular species that are not modified with NBS by enrichment from the view point of improvement in quantitativeness.

It is an object of the present invention to provide a cost-effective and sensitive detection method capable of predominantly detecting an objective substance in mass spectrometry.

The present invention encompasses the following aspects.

(1) A mass spectrometric method comprising:

in a mass spectrometry specifically ionizing a specific substance to be measured contained in a mixture sample containing the specific substance and a substance other than the specific substance by using a matrix that is more likely to ionize the specific substance than the substance other than the specific substance, to selectively measure the specific substance from the mixture.

That is, the matrix of the present invention can specifically ionize the specific substance because it mainly ionizes the specific substance and hard to ionize the substance other than the specific substance.

(2) The mass spectrometric method according to the above (1), wherein the specific substance is a substance related to a living organism.

(3) The mass spectrometric method according to the above (2), wherein the substance related to a living body is selected from protein, peptide, sugar, and lipid.

(4) The mass spectrometric method according to any one of the above (1) to (3), wherein the specific substance is labeled with an isotope.

(5) The mass spectrometric method according to any one of the above (1) to (4), wherein the matrix can interact with the specific substance via van der Waals interaction.

(6) The mass spectrometric method according to any one of the above (1) to (5), wherein the specific substance is a π electron containing substance, and the matrix is a π electron containing substance.

That is, in this aspect of the present invention, π-π electrons interaction between the specific substance to be measured and the matrix is used.

(7) The mass spectrometric method according to any one of the above (1) to (5), wherein the specific substance is a hydrophilic substance, and the matrix is a hydrophilic substance.

That is, in this aspect of the present invention, hydrophilic interaction between the specific substance to be measured and the matrix is used.

(8) The mass spectrometric method according to any one of the above (1) to (6), wherein the specific substance is a hydrophobic substance, and the matrix is a hydrophobic substance.

That is, in this aspect of the present invention, hydrophobic interaction between the specific substance to be measured and the matrix is used.

The followings are inventions related to the above aspect (8).

(9) The mass spectrometric method according to the above (8), wherein the specific substance is a hydrophobic peptide or a hydrophobic protein.

(10) The mass spectrometric method according to the above (9), wherein the hydrophobic peptide or the hydrophobic protein has a benzene ring and/or an aromatic ring other than a benzene ring.

(11) The mass spectrometric method according to the above (9) or (10), wherein the hydrophobic peptide or the hydrophobic protein further has a nitro group.

(12) The mass spectrometric method according to any one of the above (9) to (11), wherein the hydrophobic peptide or the hydrophobic protein has a nitrobenzenesulfenyl group or a nitrophenyl group.

(13) The mass spectrometric method according to any one of the above (9) to (12), wherein the hydrophobic peptide or the hydrophobic protein is obtained by chemically modifying a peptide or a protein corresponding to the hydrophobic peptide or the hydrophobic protein by using a hydrophobic compound having a benzene ring, an aromatic ring other than a benzene ring, and/or a nitro group.

This aspect encompasses the case where the peptide or the protein corresponding to the hydrophobic peptide or the hydrophobic protein itself is hydrophobic. In other words, this aspect encompasses the case where a hydrophobic peptide or a hydrophobic protein is derived into a peptide or protein having higher hydrophobicity through chemical modification using a hydrophobic compound.

(14) The mass spectrometric method according to the above (13), wherein the hydrophobic compound is a sulfenyl compound.

(15) The mass spectrometric method according to the above (13) or (14), wherein the sulfenyl compound is 2-nitrobenzenesulfenyl chloride.

(16) The mass spectrometric method according to any one of the above (8) to (15), wherein the matrix is a substituted compound of a benzene ring or an aromatic ring other than a benzene ring, having a functional group for transferring electric charges from/to the specific substance to be measured and a functional group for affording hydrophobicity to the matrix molecule itself.

(17) The mass spectrometric method according to the above (16), wherein the functional group for transferring electric charges is selected from carboxyl group, hydroxyl group, amino group, sulfate group, nitrate group, and aldehyde group.

(18) The mass spectrometric method according to the above (16) or (17), wherein the functional group for affording hydrophobicity is nitro group.

(19) The mass spectrometric method according to any one of the above (8) to (18), wherein the matrix is a nitrobenzoic acid derivative or a nitrophenol derivative.

(20) The mass spectrometric method according to any one of the above (8) to (19), wherein the matrix is a hydroxynitrobenzoic acid derivative.

(21) The mass spectrometric method according to any one of the above (8) to (20), wherein the matrix is selected from positional isomers of hydroxynitrobenzoic acid.

(22) The mass spectrometric method according to any one of the above (8) to (18), wherein the matrix is selected from 4-nitroaniline, 2,4-dinitroaniline, 2-bromo-4,6-dinitroaniline, 4-nitrophenol, 2-nitrophenol, 2,5-dinitrophenol, 4-nitrobenzoic acid, 3-hydroxy-4-nitrobenzoic acid, and 3-hydroxy-2-nitrobenzoic acid.

(23) The mass spectrometric method according to any one of the above (8) to (22), wherein as the matrix, a mixed matrix combined with α-cyano-4-hydroxycinnamic acid is used.

(24) The mass spectrometric method according to any one of the above (8) to (23), wherein the matrix is used as a solution of 1 mg/ml to a saturated concentration.

(25) The mass spectrometric method according to the above (23) or (24), wherein the α-cyano-4-hydroxycinnamic acid is used as a solution of 1 mg/ml to a saturated concentration.

(26) The mass spectrometric method according to the above (25), wherein the matrix solution and the solution of α-cyano-4-hydroxycinnamic acid are used in a volume ratio of 1:10 to 10:1.

According to the present invention, it is possible to provide a method capable of predominantly detecting an objective substance in mass spectrometry without enriching the objective substance to be measured.

### BRIEF DESCRIPTION OF THE DRAWINGS

FIG. 1 shows mass spectra ((a) and (b)) obtained by the conventional method and mass spectra ((c) and (d)) obtained by the present invention when the sample to be measured is a mixture of ACTH peptide and ACTH peptide modified with NBS Reagent (light);

FIG. 2 shows a mass spectrum (a) obtained by the conventional method and a mass spectrum (b) obtained by the present invention when the sample to be measured is prepared by digesting a 1:1 mixture of NBS Reagent (heavy) modified- and NBS Reagent (light) modified-four purified proteins (ovalbumin, glyceraldehyde-3-phosphate dehydrogenase, lysozyme, and α-lactalbumin);

FIG. 3 shows a mass spectrum (a) obtained by the conventional method and a mass spectrum (b) obtained by the present invention when the sample to be measured is a mixture of DSIP peptides and DSIP peptides modified with NBS Reagent (light);

FIG. 4 shows a mass spectrum (a) obtained by the conventional method and a mass spectrum (b) obtained by the present invention when the sample to be measured is a mixture obtained by nitrating lysozyme followed by digesting with trypsin;

FIG. 5 is a partially enlarged view of FIG. 4;

FIG. 6 shows a mass spectrum (a) obtained by the conventional method and a mass spectrum (b) obtained by the present invention when the sample to be measured is a mixture of peptide IRRP1 modified with NBS Reagent (light) and unmodified peptide IRRP1;

FIG. 7 includes a mass spectrum (a) obtained by the conventional method and a mass spectrum (b) obtained by the present invention when the sample to be measured is peptide HIV subIII containing p-nitrophenylalanine;

FIG. 8 includes a mass spectrum (a) obtained by the conventional method and mass spectra ((b) and (c)) obtained by the present invention when the sample to be measured is ACTH modified with NBS Reagent (light) and unmodified ACTH;

FIG. 9 includes a mass spectrum (a) obtained by the conventional method and mass spectra ((b), (c), (d) and (e)) obtained by the present invention when the sample to be measured is ACTH modified with NBS Reagent (light) and unmodified ACTH; and

FIG. 10 shows a mass spectrum (f) obtained by the conventional method and mass spectra ((a), (b), (c), (d), (e) and (g)) obtained by the present invention when the samples to be measured are prepared by digesting a 1:1 mixture of NBS Reagent (heavy) modified- and NBS Reagent (light) modified-four purified proteins (ovalbumin, glyceraldehyde-3-phosphate dehydrogenase, lysozyme, and α-lactalbumin).

### DETAILED DESCRIPTION OF THE INVENTION

In the following, the present invention will be described in detail. The mechanism of ionization in the MALDI method is not completely elucidated. The concept described in the present specification is based on the understandings predominantly supported in the art, however it still remains in the realm of speculation.

A sample to be subjected to mass spectrometry is a mixture containing a specific substance to be measured and a substance other than the specific substance. A matrix which is more likely to ionize the specific substance to be measured than the substance other than the specific substance is used. Preferably, a matrix that mainly ionizes the specific substance to be measured, but hardly ionizes the substance other than the specific substance is used (hereinafter, the substance other than the specific substance is referred to as “other substances” in some cases).

In the MALDI method, the analyte molecule and the matrix are vaporized and ionized almost simultaneously. In other words, the matrix assists ionization of the analyte molecule while dispersing the analyte molecule at the molecular level. In order to vaporize and ionize efficiently, affinity between the matrix and the analyte molecule would be important. Higher affinity between the matrix and the analyte molecule will be easy of uniform dispersion of the analyte molecule in the matrix at the molecular level, or easy of uniform formation of mixed crystal.

Therefore, from the view point of the relationship between ionization and affinity, in the present invention, preferably, the matrix has a structure having affinity with the specific substance, the specific substance has a structure having affinity with the matrix, and other substances do not have such a structure. In the present invention, combination of the specific substance and the matrix from the view point of affinity therebetween allows specific ionization of the specific substance.

Examples of the specific substance include, but not limited to, substances related to a living organism such as proteins, peptides, sugars, lipids, and the like. In contrast to the specific substance, the other substance than the specific substance is not particularly limited insofar as they do not have the structure having affinity with the matrix. Generally, in the present invention, when the specific substance is a substance related to a living organism, the other substance is also a living organism-related substance belonging to a similar category with the specific substance insofar as it lacks the structure as described above. For example, when the specific substance is a peptide, the other substance is often a peptide not having the aforementioned structure. In the present invention, the other substance may include substances existing with and byproducts in the course of preparing the specific substance.

The terms proteins, peptides, sugars, and lipids used herein include modified compounds thereof. The modified compounds also include chemically-modified compounds. When the modified compound corresponds to the specific substance, the modified compound has a group having a structure that has affinity with the matrix, and the chemically-modified compound is obtained by chemically-modifying with the group having the aforementioned structure.

The specific substance may be isotope-labeled. In this case, the specific substance may be a mixture of a labeled substance and an unlabeled substance corresponding thereto.

One example of a sample mixture that is an object of mass spectrometry is a mixture of modified peptide and unmodified peptide as is obtained in the NBS method described in the foregoing conventional art. In this sample mixture, a modified peptide is selectively detected as a specific substance. As described above, in the NBS method, the modified peptide selected as a specific substance to be detected is basically a mixture of peptide modified with a stable isotope (¹³C)-labeled compound and peptide modified with an unlabeled compound. In the present invention, by using a matrix that predominantly ionizes modified peptides and hardly ionizes unmodified peptides, it is possible to specifically ionize the modified peptides. In this way, by using the present invention, it is possible to selectively detect modified peptides in mass spectrometry even in a mixture state without separating the modified peptides and the unmodified peptides.

As is already mentioned above, the present invention utilizes affinity between a matrix and an analyte molecule. As an interaction that leads such affinity, van der Waals interaction, π-π electrons interaction, hydrophilic interaction, hydrophobic interaction, or the like is used. Depending on the sample to be measured, a substance that is able to interact with the specific substance in the sample through the above interaction is selected as a matrix. For example, when the specific substance is a π electron containing compound, a π electron containing compound may be selected for the matrix to utilize the π-π electrons interaction therebetween. When the specific substance is a hydrophobic compound, a hydrophobic compound may be selected for the matrix to utilize the hydrophobic interaction therebetween. When the specific substance is a hydrophilic compound, a hydrophilic compound may be selected for the matrix to utilize the hydrophilic interaction therebetween. Preferably the kind of the specific substance to be measured and the kind of the matrix is selected so that the above interactions are combined. The matrix thus selected would homogenously mingles with the specific substance through the above interaction, or forms uniform mixed crystal, enabling predominant vaporization and ionization of the specific substance as well as its own vaporization and ionization.

Now the specific substance to be measured will be explained when the specific substance to be measured is a hydrophobic peptide or a hydrophobic protein. In the present invention, the term “hydrophobic peptide” or “hydrophobic protein” refers to those having relatively high contents of hydrophobic amino acids, especially highly-hydrophobic amino acids, of the amino acid composition of such peptide or protein; those having the groups exemplified below; and those having chemical modifications as described below. Examples of the highly-hydrophobic amino acids include tryptophan, isoleucine, tyrosine, phenylalanine, leucine, valine, and methionine. Alanine, glycine, proline, and the like are also considered as hydrophobic amino acids in some cases. Further, the hydrophobic peptide or hydrophobic protein preferably has a benzene ring and/or an aromatic ring other than benzene ring, and preferably has a nitro group.

The present invention is usefully applied, in particular, to a hydrophobic peptide or hydrophobic protein having a benzene ring and/or aromatic ring other than benzene ring which has a nitro group as a substituent. More specifically, the hydrophobic peptide or hydrophobic protein more preferably has a nitrobenzenesulfenyl group (NBS group: NO₂PhS in which Ph represents a phenylene group) or nitrophenyl group. Protein or peptide containing a nitrotyrosine residue, a nitrophenylalanine residue, a tryptophan residue having a NBS group as a substituent, or a cysteine residue having a NBS group as a substituent is exemplified.

The hydrophobic peptide or hydrophobic protein may be obtained by chemically modifying a corresponding peptide or protein with a hydrophobic compound. This aspect encompasses the case where the peptide or protein corresponding to the hydrophobic peptide or the hydrophobic protein itself is hydrophobic. In other words, this aspect encompasses the case where a hydrophobic peptide or a hydrophobic protein is derived into a peptide or protein having higher hydrophobicity through chemical modification using a hydrophobic compound. As the hydrophobic compound, hydrophobic compounds having a benzene ring, an aromatic ring other than benzene ring and/or a nitro group may be exemplified. In the present invention, the hydrophobic compound is preferably a sulfenyl compound. “Sulphenyl compound” is a compound that specifically modifies a tryptophan residue and a cysteine residue in a peptide or a protein. Particularly preferred examples of the sulfenyl compound include 2-nitrobenenesulfenyl chloride (NBS reagent). That is, an example of the hydrophobic peptide or hydrophobic protein preferred in the present invention is those obtained by chemically modifying a peptide or protein having a tryptophan residue or a cysteine residue using a NBS reagent.

The hydrophobic peptide or hydrophobic protein may be obtained by nitrating a corresponding peptide or protein. As is already mentioned, the corresponding peptide or protein may itself be hydrophobic. Another example of a preferred hydrophobic peptide or hydrophobic protein in the present invention is those obtained by nitration by an electrophilic aromatic substitution of a peptide or protein having a benzene ring and/or an aromatic ring other than benzene ring using a conventionally used method.

A preferred matrix used together with such a hydrophobic peptide or a hydrophobic protein is a substituted aromatic compound having a functional group for transferring electric charges from/to the specific substance to be measured and a functional group for affording hydrophobicity to the matrix molecule itself. As the substituted aromatic compound, a substituted benzene compound is preferred. A functional group for transferring electric charge is a functional group for transferring an electron or a proton, and examples of such a functional group include carboxyl group, hydroxyl group, amino group, sulfate group, nitrate group and aldehyde group. As a functional group for affording hydrophobicity, a nitro group is exemplified.

Among these substituted aromatic compounds, a nitrobenzoic acid derivative, a nitrophenol derivative and a hydroxynitrobenzoic acid derivative are preferred in the present invention. In particular, those selected from ten aromatic positional isomers of hydroxynitrobenzoic acid (HNBA) are preferred.

Concrete examples of the present invention include 4-nitroaniline (4NA: Formula (I) below), 2,4-dinitroaniline (2,4DNA: Formula (II) below), 2-bromo-4,6-dinitroaniline (2B4,6DNA: Formula (III) below), 4-nitrophenol (4NP: Formula (IV) below), 2-nitrophenol (2NP: Formula (V) below), 2,5-dinitrophenol (2,5DNP: Formula (VI) below), 4-nitrobenzoic acid (4NBA: Formula (VII) below), 3-hydroxy-4-nitrobenzoic acid (3H₄NBA: Formula (VIII) below), and 3-hydroxy-2-nitrobenzoic acid (3H₂NBA: Formula (IX) below). Structural formulas of these compounds are shown below.

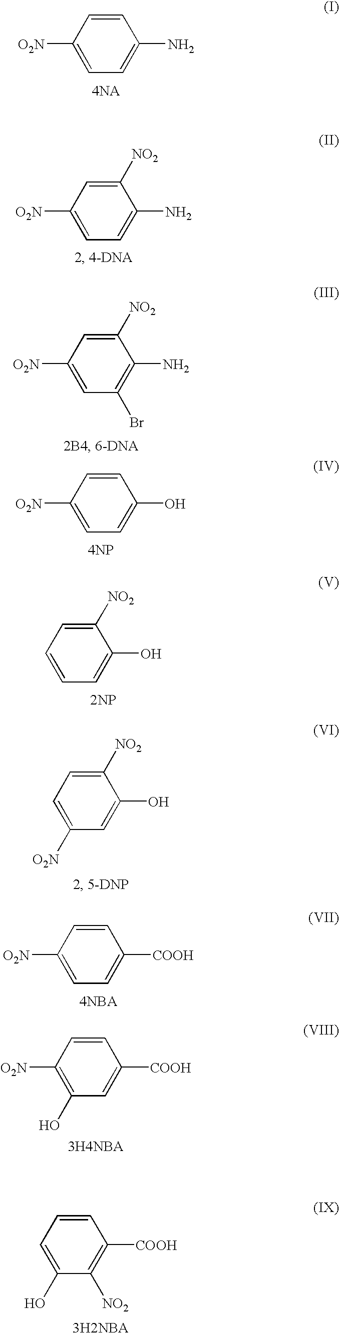

A person skilled in the art may appropriately determine the use form of these compounds in view of the use as a matrix for mass spectrometry. For example, these compounds are preferably used in a solution state. For example, the solution may be used at a concentration of 1 mg/ml to a saturated concentration.

Preferred solvents used in preparing the above solution include an aqueous solution of acetonitrile, an aqueous solution of trifluoroacetic acid (TFA), or an aqueous solution of acetonitrile-trifluoroacetic acid (TFA). When the aqueous solution of acetonitrile or the aqueous solution of acetonitrile-TFA is used, the concentration of acetonitrile may be, but not limited to, not more than 90%, preferably about 50%. When the aqueous solution of TFA or the aqueous solution of acetonitrile-TFA is used, the concentration of TFA may be, but not limited to, not more than 1%, preferably about 0.1%.

2,4-dinitroaniline, 2-bromo-4,6-dinitroaniline, 3-hydroxy-4-nitrobenzoic acid, 4-nitrobenzoic acid, and 3-hydroxy-4-nitrobenzoic acid may be dissolved in the above solvent and may be used as a matrix solution having a concentration of, for example, but not limited to, 1 mg/ml to a saturated concentration, preferably 10 mg/ml. 4-nitroaniline, 4-nitrophenol, 2-nitrophenol, 2,5-dinitrophenol, and 3-hydroxy-2-nitrobenzoic acid may be dissolved in the above solvent and may be used as a matrix solution having a concentration of, for example, but not limited to 1 mg/ml to a saturated concentration, preferably a saturated concentration.

The amount expressed as % in this description is on the basis of v/v % unless otherwise specified.

In the present invention, especially preferred combination of the specific substance to be measured and the matrix is a peptide or protein modified with NBS reagent and a substituted aromatic compound having a nitro group. Both of the specific substance to be measured and the matrix recited above have a nitrobenzene structure.

As is already mentioned, in the MALDI method, the analyte and the matrix are vaporized and ionized almost simultaneously. Accordingly, affinity between the analyte and the matrix that is required for forming uniform mixed crystal is thought to be related in detection of the analyte. In a specific detection of NBS-modified peptide or protein using a substituted aromatic compound having a nitro group as a matrix, the combination of the analyte and the matrix is thought to be related with existence of a nitro group, as well as with affinity caused by hydrophobic interaction and π-π electrons interaction.

Since the specific sample to be measured and the matrix are combined in a preferable way, the present invention is applied especially usefully to a sample to be measured which is not subjected to a treatment such as enrichment/separation. Enrichment/separation is sometimes difficult or inadequate, and this may lead increase in handling processes up to measurement and concomitant increase in loss of sample, time, cost and the like. Hence, the method of the present invention is very convenient and cost-effective. It goes without saying that the present invention that enables specific detection with high sensitivity can be usefully applied to a sample to be measured having subjected to a treatment such as enrichment/separation.

In the present invention, in addition to the use of each compounds recited above by itself as a matrix, a mixed matrix as follows is also preferably used.

A mixed matrix of the present invention is a mixture of the above matrix and α-cyano-4-hydroxycinnamic acid (4-CHCA, Formula (X) below). α-cyano-4-hydroxycinnamic acid is a compound widely used as a matrix in mass spectrometric analysis of a peptide. (Hereinafter, a singularly used matrix in which it is used without combining with 4-CHCA, and a mixed matrix in which 4-CHCA is used in combination are sometimes collectively described as matrix.)

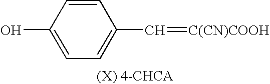

The matrix and 4-CHCA may be combined, for example, in the following quantitative relationship in nonrestrictive manner.

The matrix may be prepared in such an amount as described above. That is, the matrix may be prepared as a solution of 1 mg/ml to saturated concentration. For example, when an aqueous solution of acetonitrile, an aqueous solution of TFA, or an aqueous solution of acetonitrile-TFA is used as a solvent, 2,4-dinitroaniline, 2-bromo-4,6-dinitroaniline, 3-hydroxy-4-nitrobenzoic acid, 4-nitrobenzoic acid, and 3-hydroxy-4-nitrobenzoic acid may be prepared as a matrix solution of 1 mg/ml to a saturated concentration, preferably a saturated concentration. For example, when the above described aqueous solution is used as a solvent, 4-nitroaniline, 4-nitrophenol, 2-nitrophenol, 2,5-dinitrophenol and 3-hydroxy-2-nitrobenzoic acid may be prepared as a matrix solution of 1 mg/ml to a saturated concentration, preferably 10 mg/ml.

On the other hand, 4-CHCA may be prepared as a solution having a concentration of 1 mg/ml to a saturated concentration. When an aqueous solution of acetonitrile, an aqueous solution of TFA or an aqueous solution of acetonitrile-TFA same as used in preparing the above matrix solution is used as a solvent, a 4-CHCA solution having a concentration of 1 mg/ml to a saturated concentration, preferably 10 mg/ml may be prepared.

The both of the solutions prepared in the above manners are mixed in a volume ratio of, preferably 1:10 to 10:1, more preferably 1:3 to 3:1, for example 1:1 for use.

The conventional matrix 4-CHCA can not necessarily detect a specific substance in a specific manner in mass spectrometry measurement of a sample to be measured not subjected to enrichment procedure. However, the matrix 4-CHCA is excellent in measuring sensitivity and has an advantage that an optimal spot on which a laser beam is focused in a mass spectrometric sample can be readily found.

On the other hand, matrixes of the present invention such as nitrobenzene derivatives, for example, 4-nitroaniline, 2,4-dinitroaniline, 2-bromo-4,6-dinitroaniline, 4-nitrophenol, 2-nitrophenol, 2,5-dinitrophenol, 4-nitrobenzoic acid, 3-hydroxy-4-nitrobenzoic acid and 3-hydroxy-2-nitrobenzoic acid are, as is described above, believed to have excellent affinity with a specific substance in a sample to be measured of the present invention, and therefore have an advantage that an efficient ionization of the specific substance can be achieved. Further, when these matrices are used in combination with 4-CHCA as a mixed matrix, synergistic effect of the advantages given by each matrix is exerted. In brief, an ability of 4-CHCA to detect with high sensitivity is added while not spoiling at a practical level the specific detectability that each of these matrices has by itself. Therefore, it is possible to conduct mass spectrometry with higher analytical efficiency.

According to the present invention, it is possible to selectively detect an objective substance. The present invention is used usefully, especially in the above NBS method, when an objective NBS-modified peptide is detected from a mixed sample containing NBS-modified peptides and unmodified peptides. Basically, in this case, pairs of peaks derived from a peptide modified with 2-nitro[³C₆]benzenesulfenyl chloride and a peptide modified with 2-nitro[¹²C₆]benzenesulfenyl chloride are specifically detected.

According to the present invention, it is possible to readily recognize a protein contained in either one of a sample to be analyzed and a reference sample. For example, when the present method is used in the step (6) of the aforementioned NBS method, a protein contained in either one of the samples can be recognized as follows. A mass spectrometric sample obtained by conducting the foregoing step (5) includes modified peptides derived from protein contained in both of the protein sample I and protein sample II (referred to as A, A′, respectively), and modified peptide from protein contained in either one of the samples (referred to as B). The mass spectrometric sample further includes unmodified peptide that failed to be removed because of inadequate enrichment/separation (referred to as C). When the conventional matrix (for example, 4-CHCA) is used and mass spectrometry is conducted, A and A′ are detected as a pair of peaks, while peptides B and C are detected as single peaks, and whether B and C are modified or unmodified is not distinguished. Contrarily, when the matrix of the present invention is used, the modified A, A′ and B are predominantly detected, while C is hardly detected. Among these predominantly detected peaks, the pair of peaks are modified peptides A and A′ derived from proteins contained in both of the samples, and the single peak is a modified peptide B derived from a protein contained in either one of the samples. In brief, among the single peaks detected in a result of mass spectrometry using the conventional matrix, the distinction can be made that: “B” which is also detected in the mass spectrometry using a matrix of the present invention is a labeled peptide derived from a protein contained in either one of the samples, and “C” which is hardly detected is an unmodified peptide.

When the NBS-modified peptide is analyzed using 4-CHCA as a matrix as is the conventional method, a peak is observed also at a position smaller by m/z value of 16 than that of the peak for the objective peptide. Also a minor peak at a position smaller by m/z value of 32 than that of the peak for the objective peptide is sometimes observed. Depending on the peptide to be measured, also a peak at a position smaller by m/z value of 155 than that of the peak for the objective peptide is observed (when modified with NBSCl (light) available from SHIMADZU). By the use of the present invention, these peaks are hardly observed and mass spectrum is simplified, which facilitates the analysis.

### EXAMPLES

The present invention will now be explained more detail by way of examples, however, the present invention is not limited to these examples. As is mentioned above, the amount expressed as % in this description is on the basis of v/v % unless otherwise specified. In Examples, labeling with a NBS reagent is also referred to as modification or NBS modification.

### Example 1

In this Example, a mixture of ACTH(5-10) peptide (purchased from BACHEM) and ACTH(5-10) peptide modified with 2-nitro[¹²C₆]benzenesulfenyl chloride (NBS Reagent (light): SHIMADZU Corporation) was used as a sample to be measured, and measurement was conducted on a mass spectrometer using matrices of the present invention 3H₄NBA (3-hydroxy-4-nitrobenzoic acid) and 4H₃NBA (4-hydroxy-3-nitrobenzoic acid), and comparative conventional matrices DHB (2,5-dihydroxy benzoic acid) and 4-CHCA α-cyano-4-hydroxy cinnamic acid).

A method for preparing samples to be measured will be described below.

Labeling of peptide was conducted by reacting 10 μg of ACTH for one hour in a sample solution prepared by adding 20 equivalents of NBS Reagent (light) in 50 μl of 70% acetic acid aqueous solution. After reaction, desalting using ZipTip (μC18) was conducted to give a modified sample. On the other hand, 10 μg of ACTH was subjected to stirring treatment for one hour in 50 μl of 70% acetic acid aqueous solution not containing NBS Reagent (light), and the resultant solution was desalted in the same manner as described above, to give an unmodified sample. The modified sample and the unmodified sample were mixed in equivalent amounts, to prepare a sample for mass spectrometry.

Four matrices including DHB, 4-CHCA, and two isomers of HNBA namely 3H₄NBA and 4H₃NBA, were prepared. These matrices were prepared by dissolving in 50% acetonitrile aqueous solution containing 0.1% TFA, and 4-CHCA, DHB and 4H₃NBA were used as a 10 mg/ml solution, and 3H₄NBA was used as a saturated solution.

0.5 μl of the above sample to be measured was taken and dropped on a target plate and dried, and then 0.5 μl of matrix solution was taken and dropped on the sample dried in advance and dried (the same operation was conducted in all following Examples). This operation was conducted for four matrices. Using target plate thus obtained, measurement was conducted using an AXIM-CFR apparatus (SHIMADZU Corporation).

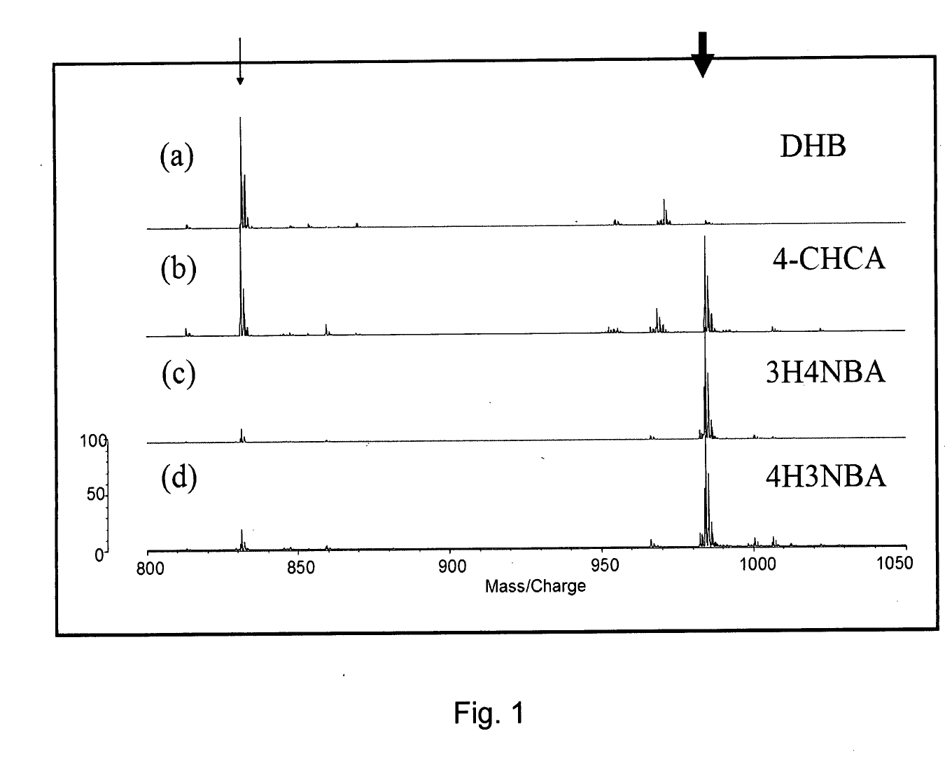

The obtained spectra are shown in FIG. 1. In FIG. 1, the horizontal axis represents mass-to-charge ratio, and the vertical axis represents relative intensity of ion (hereinafter, in any figures, the horizontal axis represents mass-to-charge ratio, and the vertical axis represents relative intensity of ion). (a) is a spectrum when DHB was used as a matrix; (b) is a spectrum when 4-CHCA was used as a matrix; (c) is a spectrum when 3H₄NBA was used as a matrix; and (d) is a spectrum when 4H₃NBA was used as a matrix. The bold arrow represents a peak position of NBS-modified ACTH peptide, namely an objective peptide, and thin arrow represents a peak position of unmodified ACTH peptide. As shown in FIG. 1, in (c) and (d) using matrices of the present invention, an objective modified peptide was selectively detected.

### Example 2

In this Example, measurement was conducted in a mass spectrometer by using a mixture of a labeled-modified protein and an unlabeled-modified protein as a sample to be measured, and using a matrix 3H₄NBA of the present invention and a comparative conventional matrix 4-CHCA.

Two sample mixtures each having a total weight of 100 μg given by each 25 μg of four purified proteins (ovalbumin, glyceraldehyde-3-phosphate dehydrogenase, lysozyme, and α-lactalbumin, all available from SIGMA) was mixed were prepared. According to a protocol “¹³CNBS Isotope Labeling Kit” (SHIMADZU), one sample mixture was modified with 2-nitro[¹³C₆]benzenesulfenyl chloride (NBS Reagent (heavy); SHIMADZU) and the other sample mixture was modified with 2-nitro[¹²C₆]benzenesulfenyl chloride (NBS Reagent (light); SHIMADZU). These two modified samples were subjected to mixing and desalting followed by reduction, alkylation and trypsin digestion. The samples were lyophilized, resuspended in 50 μl of 0.1% TFA aqueous solution, and subjected to desalting treatment with ZipTip (μC18). Using the resultant solution as a sample to be measured, and using the same matrix solutions of 4-CHCA and 3H₄NBA as in Example 1, measurement was conducted in the same manner as in Example 1 by a mass spectrometer.

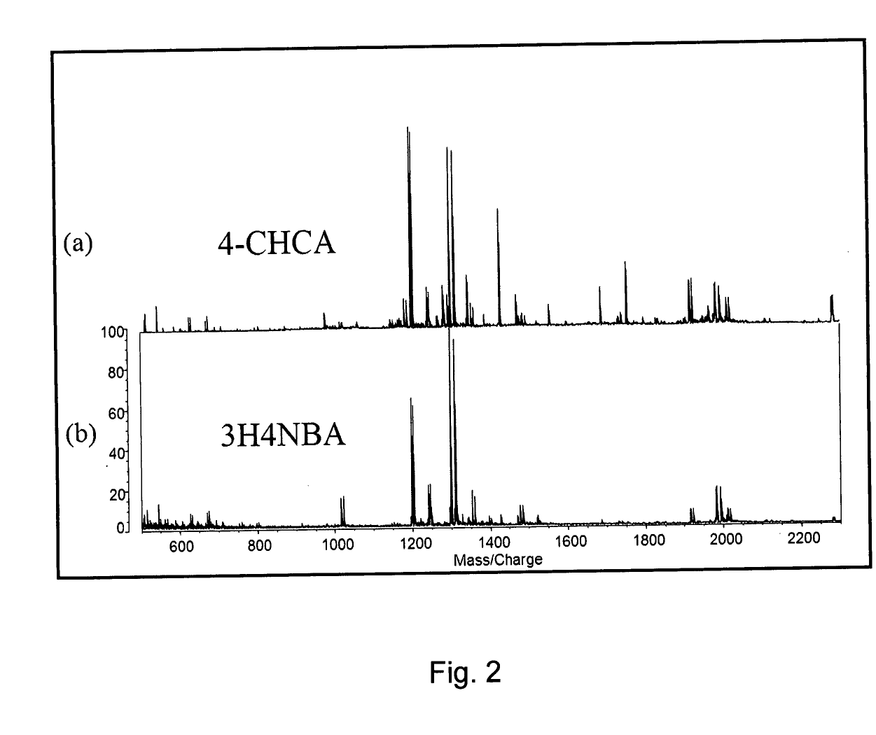

The obtained spectra are shown in FIG. 2. In FIG. 2, (a) is a spectrum when 4-CHCA was used as a matrix and (b) is a spectrum when 3H₄NBA was used as a matrix. In FIG. 2, among the peaks detected in (a), pairs of peaks of the objective modified peptides having a difference of m/z value of 6 or 12 that is corresponding to a mass difference between the two reagents used in the modification, the NBS Reagent (heavy) (2-nitro[¹³C₆]benzenesulfenyl chloride) and the NBS Reagent (light) (2-nitro[¹²C₆]benzenesulfenyl chloride) or a mass difference between their multiples were selectively detected in (b) using a matrix of the present invention.

### Example 3

In Example 3, using a mixture of DSIP peptide (delta sleep-inducing peptide (Peptide Institute): 500 fmol) and DSIP peptide modified with NBS Reagent (light) (500 fmol) as a sample to be measured, and using the matrix 3H₄NBA of the present invention and the comparative conventional matrix 4-CHCA, measurement was conducted using a mass spectrometer.

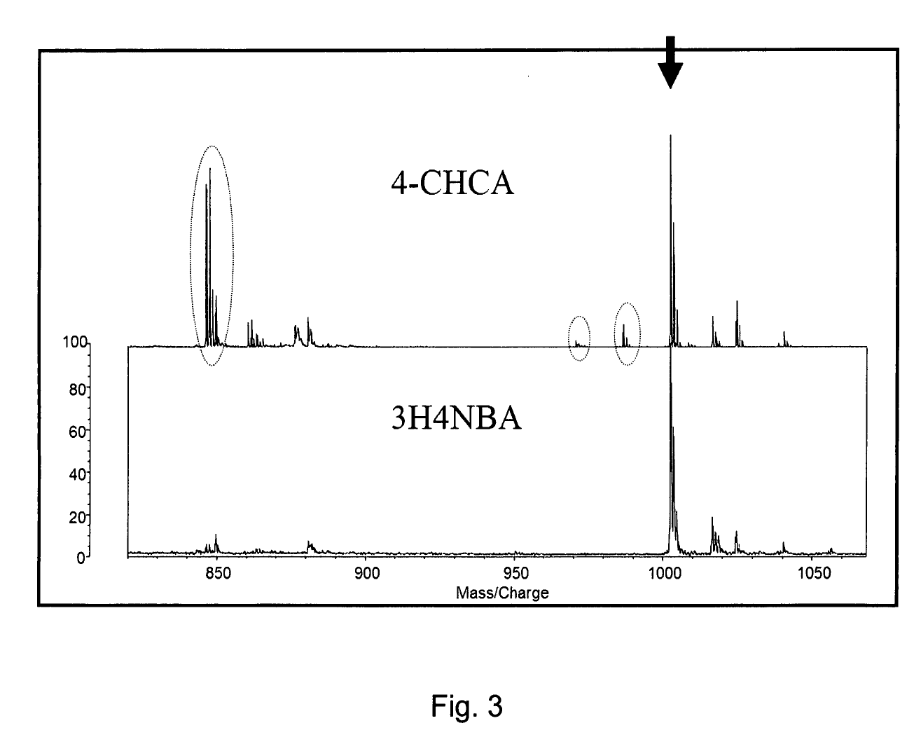

Modification was conducted in the same manner as in Example 1 except that DSIP peptide was used as a sample for modification, to obtain a sample to be measured. Using the same matrix solutions of 4-CHCA and 3H₄NBA as in Example 1 as matrices, measurement was conducted using a mass spectrometer in the same manner as in Example 1. The obtained spectrua are shown in FIG. 3. In FIG. 3, (a) is a spectrum using 4-CHCA as a matrix, and (b) is a spectrum using 3H₄NBA as a matrix. The bold arrow represents a position of NBS modified DSIP peptide, and the part surrounded by the ellipse of dotted line shows the peaks smaller than the peak indicated by the arrow by m/z value of 16, 32, and 155, respectively. These peaks observed in (a) were hardly observed in (b) using the matrix of the present invention. This demonstrates that the peaks of the objective peptides were selectively detected.

### Example 4

In this Example, lysozyme was reduced and alkylated, and then, nitrated and digested with trypsin. Measurement was conducted by a mass spectrometer using the resultant digested product as a sample to be measured, and using the matrix 3H₄NBA of the present invention and the comparative conventional matrix 4-CHCA.

Now, a preparation method of sample to be measured will be described.

First, 1 mg of lysozyme was reduced and alkylated according to a conventional method. Next, according to the method described in Riordan J. F. et al., 1996; Sokolovsky M. et al., 1966, nitration was conducted using tetranitro methane. Thereafter, trypsin was added according to a conventional method to digest into peptide fragments. A portion of the obtained digested product corresponding to 14 μg was lyophilized and then dissolved in 50 μl of 0.1% TFA aqueous solution, and desalted with ZipTip μ-C18. Thus obtained digested product was used as a sample to be measured. In this sample to be measured, tyrosine residues of a peptide fragment was partly nitrated. That is, this sample was a mixture of peptide fragment containing nitrotyrosine, peptide fragment containing tyrosine not nitrated, and peptide fragment not containing tyrosine.

As a matrix, the comparative conventional 4-CHCA (α-cyano-4-hydroxycinnamic acid: purchased from SIGMA), or 3H₄NBA (3-hydroxy-4-nitrobenzoic acid: purchased from ALDRICH) was used. These matrices were dissolved in 50% acetonitrile aqueous solution containing 0.1% TFA and 4-CHCA was used as a solution of 10 mg/ml and 3H₄NBA was used as a saturated solution.

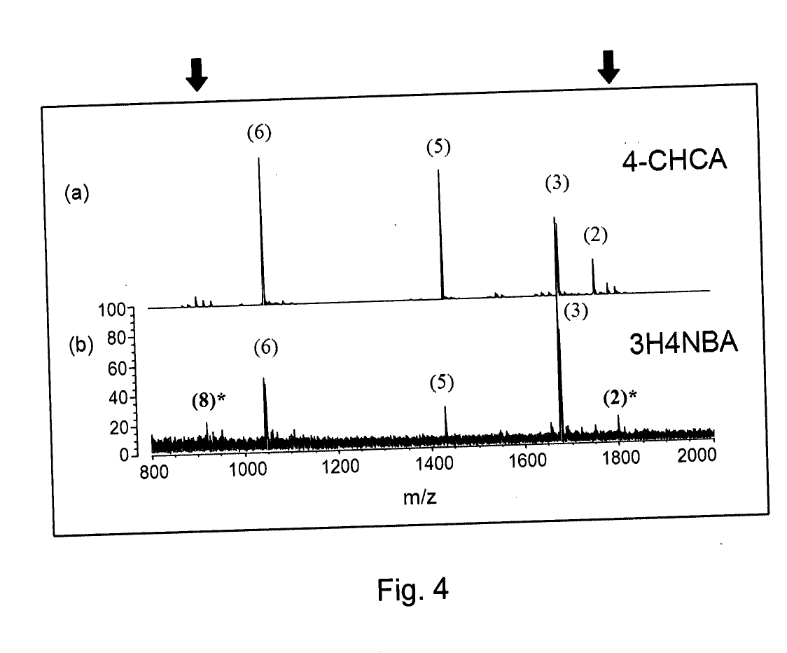

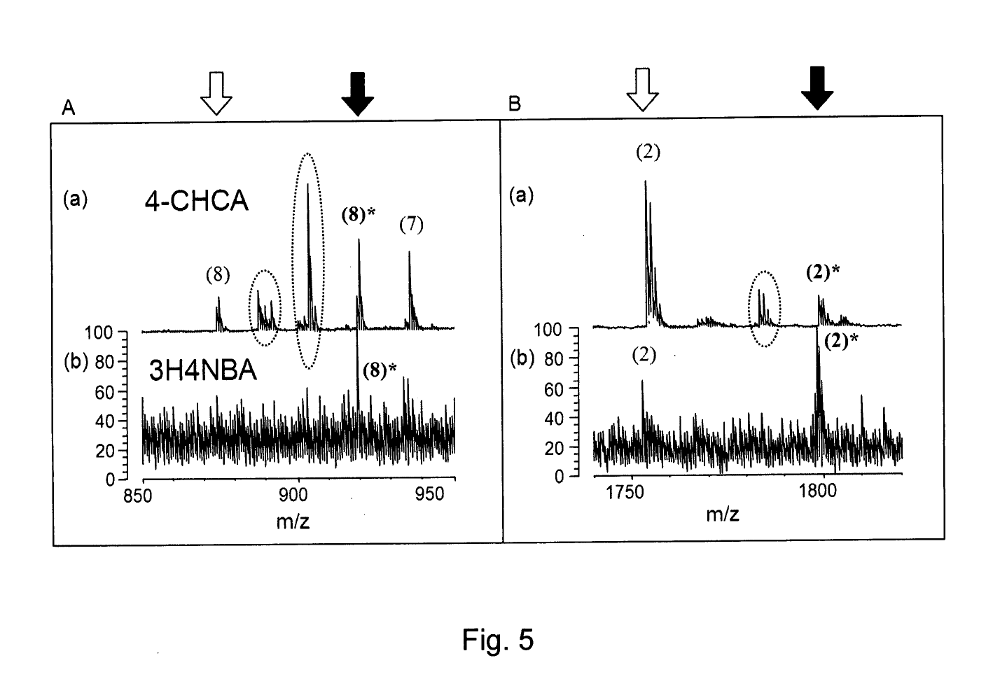

Using the above matrix, the above sample to be measured was subjected to MS measurement in a reflectron mode using a mass spectrometer AXIMA-CFR (SHIMADZU). In every following Example, MS measurement was also conducted in a reflectron mode using the AXIMA-CFR. The obtained spectra are shown in FIG. 4 and FIG. 5 (A and B). FIG. 5A is an enlarged view of m/z value of 850 to 960 part in FIG. 4, and FIG. 5B is an enlarged view of m/z value of 1740 to 1820 part of FIG. 4. In FIG. 4 and FIG. 5 (A and B), (a) is a spectrum measured using 4-CHCA as a matrix and (b) is a spectrum measured using 3H₄NBA as a matrix.

The peaks indicated by the filled arrows ((2*): m/z=1798.83; Asn-Thr-Asp-Gly-Ser-Thr-Asp-Tyr*-Gly-Ile-Leu-Gln-Ile-Asn-Ser-Arg (SEQ ID NO: 1) and (8*): m/z=919.41; His-Gly-Leu-Asp-Asn-Tyr*-Arg (SEQ ID NO: 2), wherein Tyr* represents a nitrated tyrosine residue) are peaks of objective trypsin-digested peptides containing nitrated tyrosine residue.

The peaks indicated by the open arrows ((2): m/z=1753.84; Asn-Thr-Asp-Gly-Ser-Thr-Asp-Tyr-Gly-Ile-Leu-Gln-Ile-Asn-Ser-Arg (SEQ ID NO: 3) and (8): m/z=874.42; His-Gly-Leu-Asp-Asn-Tyr-Arg (SEQ ID NO: 4)) are peaks of digested peptides having the same sequences as the above objective digested peptides except that they failed to be nitrated.

The peaks not indicated by arrows (3): m/z=1675.80; Ile-Val-Ser-Asp-Gly-Asn-Gly-Met-Asn-Ala-Trp-Val-Ala-Trp-Arg (SEQ ID NO: 5), (5): m/z=1268.61; Gly-Tyr-Ser-Leu-Gly-Asn-Trp-Val-Cys-Ala-Ala-Lys (SEQ ID NO: 6) and (6): m/z=1045.54; Gly-Thr-Asp-Val-Gln-Ala-Trp-Ile-Arg (SEQ ID NO: 7) are peaks of trypsin-digested peptides derived from lysozyme.

The peaks surrounded by the ellipse of dotted line are the peaks that are smaller by m/z value of 16 or 32 than the peaks of the above objective digested peptides.

As shown in these Figs., only when 3H₄NBA was used as a matrix, peaks of the objective peptide fragments containing nitrated tyrosine residue were clearly detected, while peaks of peptide fragments containing a non-nitrated tyrosine residue and the aforementioned peaks smaller by m/z value of 16 or 32 were hardly detected. In other words, by using 3H₄NBA as a matrix, only the objective peaks were selectively detected.

### Example 5

In Example 5, using a mixture of peptide whose cysteine is modified with NBS reagent (2-nitrobenzenesulfenyl chloride (MW=189.62): SHIMADZU) and unmodified peptide as a sample to be measured, and using the matrix 3H₄NBA of the present invention and the comparative conventional matrix 4-CHCA, measurement was conducted using a mass spectrometer.

The preparing method of the sample to be measured will be described below.

First, 10 μg of peptide IRRP1 (Cys-Leu-Lys-Asp-Arg-His-Asp (SEQ ID NO: 8) purchased from BACHEM) was dispensed using 50% acetonitrile aqueous solution containing 0.1% TFA, and lyophilized. This was then dissolved in 15 μl of Milli-Q water (Millipore). The resultant solution was mixed with 35 μl of NBS reagent solution (0.17 mg of NBS reagent was dissolved in 35 μl of acetic acid) and allowed to react for an hour at room temperature. The reaction product was desalted using ZipTip μ-C18 to give a modified peptide sample.

Separately, 10 μg of peptide IRRP1 was dissolved in 15 μl of Milli-Q water. The resultant solution was mixed with 35 μl of acetic acid, left for an hour at room temperature, and desalted with ZipTip μ-C18 to give an unmodified peptide sample.

Equivalent amounts of the modified peptide sample and the unmodified peptide sample were mixed, to prepare a sample to be measured.

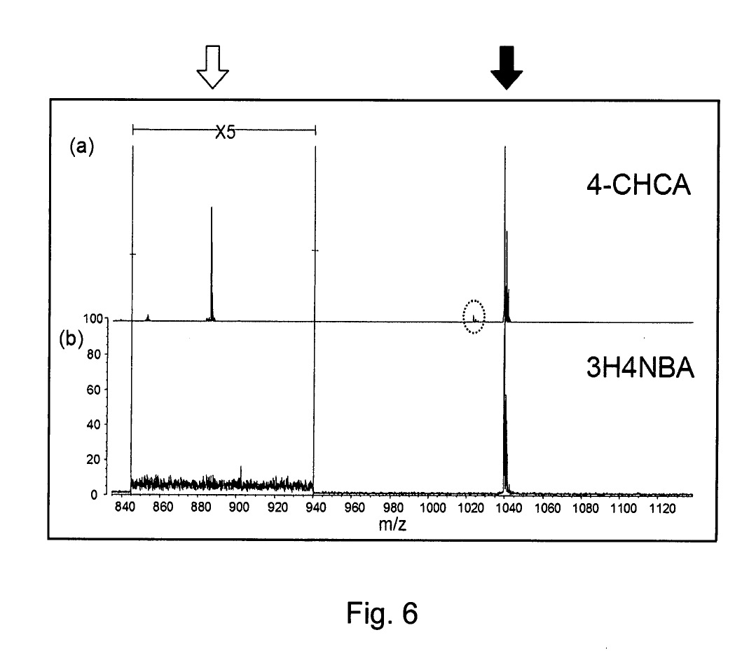

The sample to be measured was subjected to measurement by a mass spectrometer while as a matrix, the same matrices as used in Example 4 were prepared and used. The obtained spectra are shown in FIG. 6. In FIG. 6, the range corresponding to m/z value of 845 to 940 indicated by “x5” is enlarged five times in the vertical direction. In FIG. 6, (a) is a spectrum measured by using 4-CHCA as a matrix, (b) is a spectrum measured by using 3H₄NBA as a matrix. Furthermore, the peak indicated by the filled arrow (m/z=1038.40) is a peak of an objective modified peptide sample, the peak indicated by the open arrow (m/z=886.42) is a peak of unmodified peptide sample, and the peak surround by the ellipse of dotted line is a peak that is smaller by m/z value of 16 than the objective peptide peak.

As shown in these Figs., only when 3H₄NBA was used as a matrix, peaks of the objective modified peptide sample were clearly detected, while peaks of unmodified peptides and the aforementioned peaks smaller by m/z value of 16 that had been detected using 4-CHCA were not detected. In other words, by using 3H₄NBA as a matrix, only the objective peaks were selectively detected.

### Example 6

In this Example, using a peptide containing p-nitro phenylalanine as a sample to be measured, and using the matrix 3H₄NBA of the present invention and the comparative conventional matrix 4-CHCA, measurement was conducted using a mass spectrometer.

The preparing method of the sample to be measured will be described below.

10 μg of peptide HIV subIII(His-Lys-Ala-Arg-Val-Leu-Phe*-Glu-Ala-nLeu-Ser-NH2 (SEQ ID NO: 9); Phe*=p-nitrophenylalanine, nLeu=norleucine, Ser-NH₂=serine whose carboxyl group is amidated; purchased from BACHEM) was dispensed using 50% acetonitrile aqueous solution containing 0.1% TFA and lyophilized. The lyophilized sample was dissolved in 50 μl of 0.1% TFA aqueous solution, and treated with ZipTip β-C18 to give a sample to be measured.

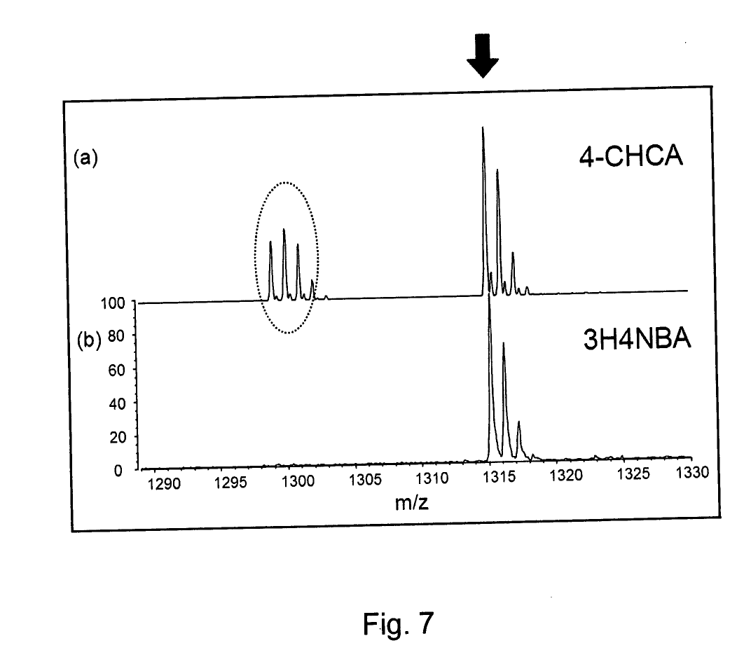

The sample to be measured was measured by a mass spectrometer while as a matrix, the same matrix as used in Example 4 were prepared and used. The obtained spectra are shown in FIG. 7. In FIG. 7, (a) is a spectrum measured using 4-CHCA as a matrix, (b) is a spectrum measured using 3H₄NBA as a matrix. Furthermore, the peak indicated by the filled arrow (m/z=1314.73) is a peak of an objective peptide HIV subIII, and the peak surround by the ellipse of dotted line is a peak that is smaller by m/z value of 16 than the objective peptide peak.

As shown in these Figs., only when 3H₄NBA was used as a matrix, only the objective peak of HIV subIII was detected, while peaks smaller by m/z value of 16 that had been detected using 4-CHCA were not detected. In other words, by using 3H₄NBA as a matrix, objective peaks were selectively detected.

### Example 7

In this Example, measurement by a mass spectrometer was conducted using a mixture of ACTH modified with NBS reagent (2-nitrobenzenesulfenyl chloride (MW=189.62): SHIMADZU) and unmodified ACTH as a sample to be measured, and using the matrices of the present invention, 2,4DNA (2,4-dinitroaniline), 2B4,6DNA (2-bromo-4,6-dinitroaniline), 4NA (4-nitroaniline), 4NBA (4-nitrobenzoic acid), 2NP (2-nitrophenol), and 2,5DNP (2,5-dinitrophenol), and the comparative conventional matrix 4-CHCA.

In the following, a preparation method of a sample to be measured will be described. As a sample to be measured, two samples having different concentrations were prepared.

A modified peptide sample (modified ACTH) was prepared in the same manner as in Example 1 except that purification by chromatography using a C18 column (YMC-Pack Pro C18: YMC) was conducted in place of the desalting treatment by ZipTip μ-C18. Equivalent moles of this modified peptide sample and unmodified peptide sample (unmodified ACTH) were mixed, and dissolved in 50% acetonitrile aqueous solution containing 0.1% TFA so that the respective concentration was 0.5 pmol/μl or 5 pmol/μl, to prepare a sample to be measured.

As the matrix, 2,4DNA, 2B4,6DNA, 4NA, 4NBA, 2NP, and 2,5DNP (4NA was purchased from SIGMA and other compounds were purchased from ALDRICH) were each dissolved in 50% acetonitrile aqueous solution containing 0.1% TFA. 4NA, 2NP, and 2,5DNP were used as solutions of 10 mg/ml, and 2,4DNA, 2B4,6DNA, and 4NBA were used as saturated solutions. The comparative conventional 4-CHCA was used as a solution of 10 mg/ml.

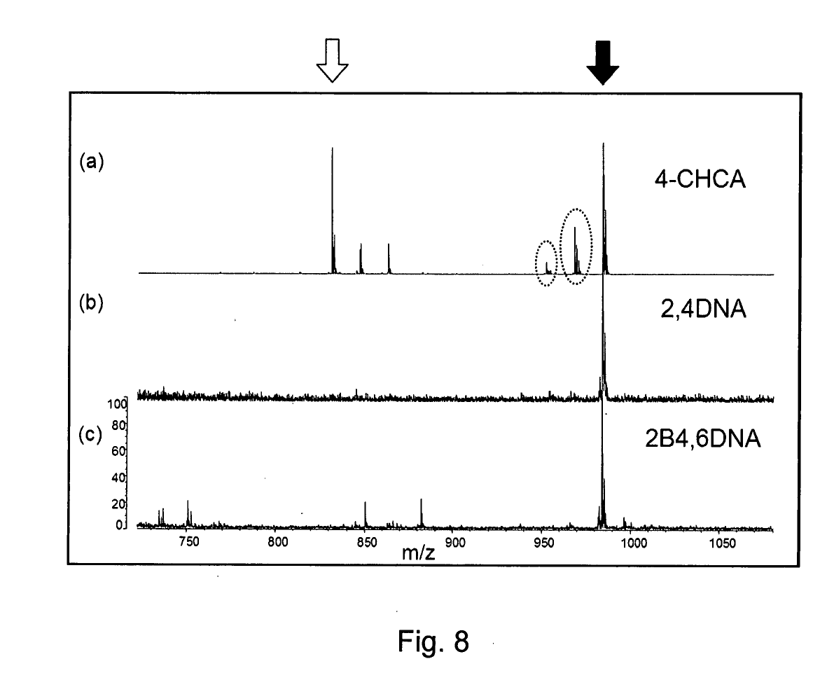

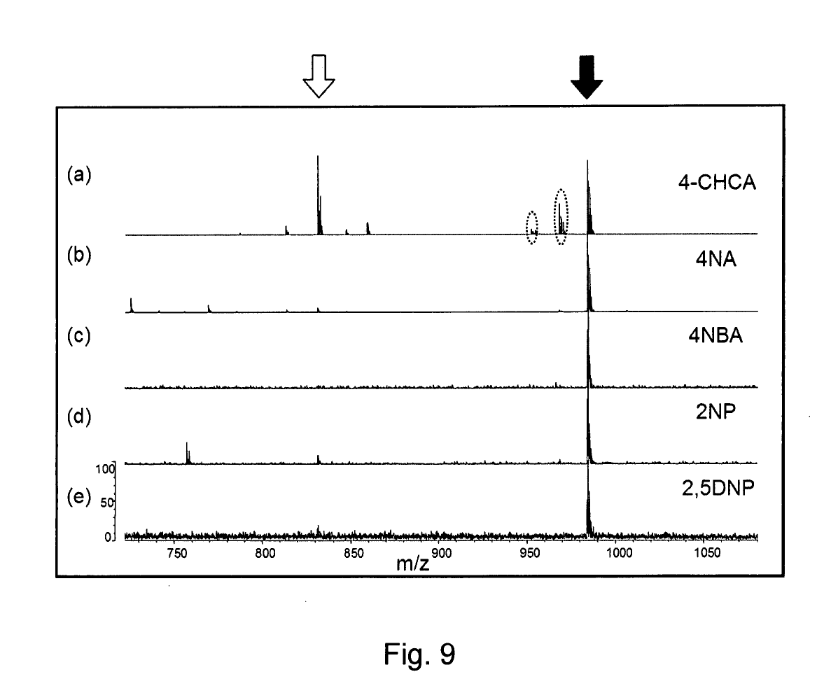

Using the above matrices and the above samples to be measured, measurement was conducted by a mass spectrometer. The obtained spectra are shown in FIG. 8 and FIG. 9.

In FIG. 8, (a) is a spectrum obtained by using 4-CHCA as a matrix, (b) is a spectrum obtained by using 2,4DNA as a matrix, and (c) is a spectrum obtained by using 2B4,6DNA as a matrix. These spectra were of the samples to be measured in which the concentrations of the modified peptide and unmodified peptide were respectively adjusted to 0.5 pmol/μl.

In FIG. 9, (a) is a spectrum obtained by using 4-CHCA as a matrix, (b) is a spectrum obtained by using 4NA as a matrix, (c) is a spectrum obtained by using 4NBA as a matrix, (d) is a spectrum obtained by using 2NP as a matrix, and (e) is a spectrum obtained by using 2,5DNP as a matrix. These spectra were of the samples to be measured in which the concentrations of the modified peptide and unmodified peptide were respectively adjusted to 5 pmol/μl.

Furthermore, the peak indicated by the filled arrow (m/z=983.37) is a peak of an objective modified peptide sample, the peak indicated by the open arrow (m/z=831.39) is a peak of unmodified peptide sample, and the peaks surround by the ellipse of dotted line are peaks that are smaller by m/z value of 16 or 32 than the objective peptide peak.

As shown in these Figs., in all cases using the matrices of the present invention, peaks of unmodified peptides and the aforementioned peaks smaller by m/z value of 16 or 32 that had been detected using 4-CHCA were not detected, while only the peaks of modified peptides were mainly detected. In other words, it is found that, by using the matrices of the present invention, only the objective peaks were selectively detected.

### Example 8

In this Example, measurement by a mass spectrometer was conducted using a mixture of NBS modified peptides and unmodified peptides as a sample to be measured, and a mixed matrix of 4-CHCA and 3H₄NBA; a mixed matrix of 4-CHCA and 3H₂NBA (3-hydroxy-2-nitrobenzoic acid); a mixed matrix of 4-CHCA and 2,4DNA; a mixed matrix of 4-CHCA and 4NA; a mixed matrix of 4-CHCA and 4NP (4-nitrophenol); and a matrix of 3H₄NBA by itself which are the matrices of the present invention and the comparative conventional matrix 4-CHCA.

Two sample mixtures each having a total weight of 100 μg given by each 25 μg of four purified proteins (ovalbumin, glyceraldehyde-3-phosphate dehydrogenase, lysozyme, and α-lactalbumin, all available from SIGMA) was mixed were prepared.

Samples to be measured were prepared in accordance with a protocol for “¹³CNBS Isotope Labeling Kit” (SHIMADZU) except that solubilization for each mixture and resolubilization for NBS-modified sample mixture were conducted using urea having a final concentration of 8M as a denaturing agent. One sample mixture was modified with a NBS Reagent (heavy) (2-nitro[¹³C₆]benzenesulfenyl chloride) and the other sample mixture was modified with a NBS Reagent (light) (2-nitro[¹²C₆]benzenesulfenyl chloride). Mixing of the both of the modified samples, reduction, alkylation, and trypsin digestion were conducted. The sample after digestion was desalted with ZipTip μ-C18, eluted with 50% acetonitrile aqueous solution containing 0.1% TFA, and the resultant eluate was used as a sample to be measured. The eluate was diluted using 50% acetonitrile aqueous solution containing 0.1% TFA to make a 10-fold dilution, and 0.5 μl of the resultant solution was applied on a target plate.

As a matrix, those prepared in the following manner were used. Using 50% acetonitrile aqueous solution containing 0.1% TFA as a solvent, 4-CHCA, 3H₄NBA, 3H₂NBA, 2,4DNA, 4NA, and 4NP were each dissolved. 4-CHCA, 3H₂NBA, 4NA, and 4NP were prepared into 10 mg/ml solutions, and 3H₄NBA and 2,4DNA were prepared into saturated solutions. As to a mixed matrix, the solutions prepared in this manner were mixed in a volume ratio of 1:1. As to the matrix 3H₄NBA used by itself and the comparative conventional matrix 4-CHCA, the solutions prepared in this manner were directly used.

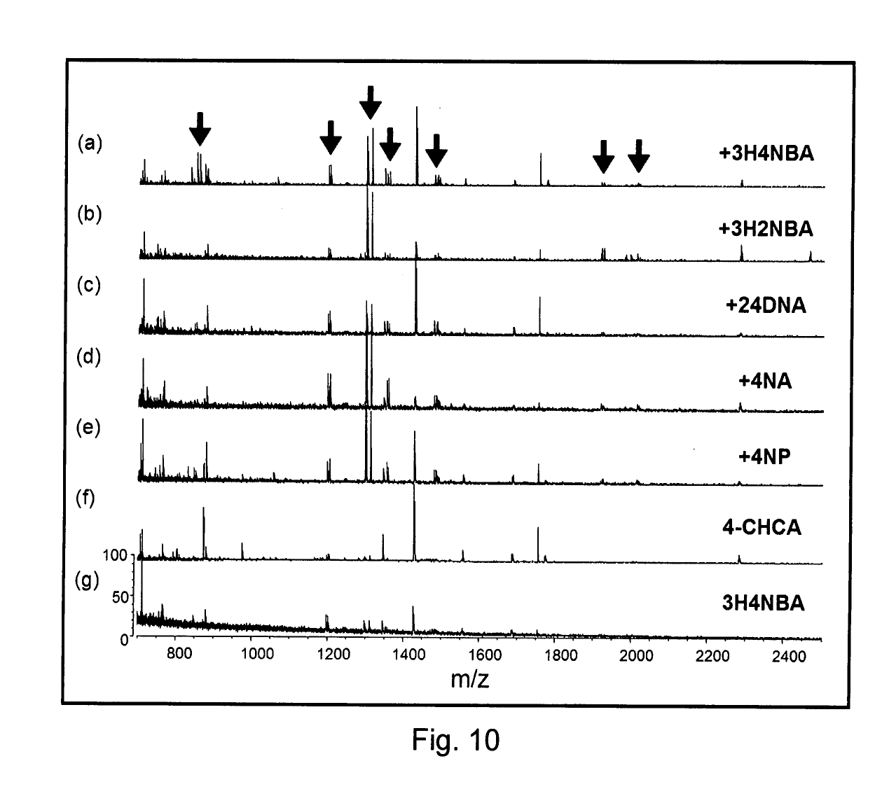

On a target plate on which a sample to be measured was applied, which was prepared in advance, 0.5 μL of the matrix solution was added and dried, and then measurement using a mass spectrometer was conducted. The obtained spectra are shown in FIG. 10. In FIG. 10, (a) is a spectrum measured by using a mixed matrix of 4-CHCA and 3H₄NBA (+3H₄NBA); (b) is a spectrum measured by using a mixed matrix of 4-CHCA and 3H₂NBA (+3H₂NBA); (c) is a spectrum measured by using a mixed matrix of 4-CHCA and 2,4DNA (+2,4DNA); (d) is a spectrum measured by using a mixed matrix of 4-CHCA and 4NA (+4NA); (e) is a spectrum measured by using a mixed matrix of 4-CHCA and 4NP (+4NP); (f) is a spectrum measured by using a comparative conventional matrix 4-CHCA; (g) is a spectrum measured by using a matrix of 3H₄NBA used by itself. Further, it is shown that the pairs of peaks indicated by the filled arrows are of the objective NBS-modified peptides. The pair of peaks of the objective peptide has a difference of m/z value of 6 or 12 corresponding to a mass difference between the two reagents used in the modification, the NBS Reagent (heavy) (2-nitro[¹³C₆]benzenesulfenyl chloride) and the NBS Reagent (light) (2-nitro[¹²C₆]benzenesulfenyl chloride) or to a mass difference between their multiples.

As shown in FIG. 10, when the mixed matrices were used as is (a) to (e), the objective peaks were detected more specifically than the case where 4-CHCA alone was used as is (f). Furthermore, in (a) to (e) using the mixed matrices, the detection sensitivity of the objective peak was better than that of the case using 3H₄NBA alone as is (g). In conclusion, (a) to (e) using the mixed matrices of the matrices of the present invention are preferable measuring conditions because the detection sensitivity improves to the same degree as the case using the conventionally used 4-CHCA, while maintaining a specific ionization ability to an objective substance that is achieved when a single compound of the matrices of the present invention as is (g) is used.

The above-described Examples show concrete eight modes within the scope of the present invention, however, the present invention can be carried out in various other modes. Therefore, the above-described Examples are merely illustrative in all respects, and must not be construed as being restrictive. Further, the changes that fall within the equivalents of the claims are all within the scope of the present invention.

What is claimed is:

1. A mass spectrometric method comprising:
in a mass spectrometry specifically ionizing a specific substance to be measured contained in a mixture sample containing the specific substance and a substance other than the specific substance by using a matrix that is more likely to ionize the specific substance than the substance other than the specific substance, to selectively measure the specific substance from the mixture.

2. The mass spectrometric method according to claim 1, wherein the specific substance is a substance related to a living organism.

3. The mass spectrometric method according to claim 2, wherein the substance related to a living organism is selected from protein, peptide, sugar, and lipid.

4. The mass spectrometric method according to claim 1, wherein the specific substance is labeled with an isotope.

5. The mass spectrometric method according to claim 1, wherein the matrix can interact with the specific substance via van der Waals interaction.

6. The mass spectrometric method according to claim 1, wherein the specific substance is a π electron containing substance, and the matrix is a π electron containing substance.

7. The mass spectrometric method according to claim 1, wherein the specific substance is a hydrophilic substance, and the matrix is a hydrophilic substance.

8. The mass spectrometric method according to claim 51, wherein the specific substance is a hydrophobic substance, and the matrix is a hydrophobic substance.

9. The mass spectrometric method according to claim 8, wherein the specific substance is a hydrophobic peptide or a hydrophobic protein.

10. The mass spectrometric method according to claim 9, wherein the hydrophobic peptide or the hydrophobic protein has a benzene ring and/or an aromatic ring other than a benzene ring.

11. The mass spectrometric method according to claim 9, wherein the hydrophobic peptide or the hydrophobic protein further has a nitro group.

12. The mass spectrometric method according to claim 9, wherein the hydrophobic peptide or the hydrophobic protein has a nitrobenzenesulfenyl group or a nitrophenyl group.

13. The mass spectrometric method according to claim 9, wherein the hydrophobic peptide or the hydrophobic protein is obtained by chemically modifying a peptide or a protein corresponding to the hydrophobic peptide or the hydrophobic protein by using a hydrophobic compound having a benzene ring, an aromatic ring other than a benzene ring, and/or a nitro group.

14. The mass spectrometric method according to claim 13, wherein the hydrophobic compound is a sulfenyl compound.

15. The mass spectrometric method according to claim 13, wherein the sulfenyl compound is 2-nitrobenzenesulfenyl chloride.

16. The mass spectrometric method according to claim 8, wherein the matrix is a substituted compound of a benzene ring or an aromatic ring other than a benzene ring, having a functional group for transferring electric charges from/to the specific substance to be measured and a functional group for affording hydrophobicity to the matrix molecule itself.

17. The mass spectrometric method according to claim 16, wherein the functional group for transferring electric charges is selected from carboxyl group, hydroxyl group, amino group, sulfate group, nitrate group, and aldehyde group.

18. The mass spectrometric method according to claim 16, wherein the functional group for affording hydrophobicity is nitro group.

19. The mass spectrometric method according to claim 8, wherein the matrix is a nitrobenzoic acid derivative or a nitrophenol derivative.

20. The mass spectrometric method according to claim 8, wherein the matrix is a hydroxynitrobenzoic acid derivative.

21. The mass spectrometric method according to claim 58, wherein the matrix is selected from positional isomers of hydroxynitrobenzoic acid.

22. The mass spectrometric method according to claim 8, wherein the matrix is selected from 4-nitroaniline, 2,4-dinitroaniline, 2-bromo-4,6-dinitroaniline, 4-nitrophenol, 2-nitrophenol, 2,5-dinitrophenol, 4-nitrobenzoic acid, 3-hydroxy-4-nitrobenzoic acid, and 3-hydroxy-2-nitrobenzoic acid.

23. The mass spectrometric method according to claim 8, wherein as the matrix, a mixed matrix combined with α-cyano-4-hydroxycinnamic acid is used.

24. The mass spectrometric method according to claim 8, wherein the matrix is used as a solution of 1 mg/ml to a saturated concentration.

25. The mass spectrometric method according to claim 23, wherein the α-cyano-4-hydroxycinnamic acid is used as a solution of 1 mg/ml to a saturated concentration.

26. The mass spectrometric method according to claim 25, wherein the matrix solution and the solution of α-cyano-4-hydroxycinnamic acid are used in a volume ratio of 1:10 to 10:1.
